(19) United States
(12) Patent Application Publication
(10) Pub. No.: US 2016/0291229 A1
(43) Pub. Date: Oct. 6, 2016

(54) METHOD FOR PRODUCING RETARDATION FILM

(71) Applicant: ZEON CORPORATION, Tokyo (JP)

(72) Inventors: Taku HATANO, Tokyo (JP); Yasuhide FUJINO, Tokyo (JP)

(73) Assignee: ZEON CORPORATION, Tokyo (JP)

(21) Appl. No.: 15/036,591

(22) PCT Filed: Nov. 12, 2014
(86) PCT No.: PCT/JP2014/079972

§ 371 Date: May 13, 2016

(30) Foreign Application Priority Data
Nov. 15, 2013 (JP) 2013-237267

(51) Int. Cl. G02B 5/30; B29D 11/00; B29C 71/02; G02F 1/13363; B29C 55/14

(52) U.S. Cl. CPC G02B 5/3083; G02B 5/305; G02F 1/13363; B29C 55/14; B29C 71/02; B29D 11/00788; G02F 2413/08; G02F 2413/14; G02F 2413/13; B29K 2069/00

(57) ABSTRACT

A method for manufacturing a phase difference film having specific optical properties from a pre-stretch film that includes a resin layer (a) made of a resin A containing polycarbonate and a resin layer (b) made of a resin B having a negative intrinsic birefringence, wherein the pre-stretch film has a property of exhibiting a phase difference that varies depending on temperatures. The method includes a stretching step of performing uniaxial stretching two or more times at different temperatures and in different directions, so that a resin layer having a specific plane orientation coefficient is obtained by stretching the resin layer (a), and a resin layer having specific birefringence and specific Nz coefficient is obtained by stretching the resin layer (b). The resin A has a specific glass transition temperature TgA, and the TgA and a glass transition temperature TgB of the resin B satisfy a specific relationship.

### FIELD

The present invention relates to a method for manufacturing a phase difference film.

### BACKGROUND

Phase difference films used for optical compensation of liquid crystal display devices and the like are required to reduce changes in color tone of display devices depending on viewing angles, and various techniques have been developed. As one of such phase difference films, there has been proposed a phase difference film in which retardation Re at an incident angle of 0° and retardation R₄₀ at an incident angle of 40° satisfy a relationship of 0.92≦R₄₀/Re≦1.08 (see Patent Literature 1).

A technique described in Patent Literature 2 is also known.

### CITATION LIST

### Patent Literature

Patent Literature 1: Japanese Patent Application Laid-Open No. 2013-137394 A

Patent Literature 2: Japanese Patent Application Laid-Open No. 2011-39338 A

### SUMMARY

### Technical Problem

The aforementioned phase difference film can be manufactured by, for example, bonding a film made of a resin having a positive intrinsic birefringence and a film made of a resin having a negative intrinsic birefringence. However, a resin having a negative intrinsic birefringence is generally low in mechanical strength and brittle. For this reason, a film made of a resin having a negative intrinsic birefringence easily ruptures when stretched, resulting in poor manufacturing efficiency.

Therefore, for preventing the breakage of the film made of a resin having a negative intrinsic birefringence, there has been made a study wherein a film including a layer made of a resin having a negative intrinsic birefringence and a film made of a resin having a positive intrinsic birefringence are stretched to manufacture a phase difference film in which retardation Re at an incident angle of 0° and retardation R₄₀ at an incident angle of 40° satisfy the relationship of 0.92≦R₄₀/Re≦1.08. According to this manufacturing method, a layer made of a resin having a negative intrinsic birefringence can be protected with a layer made of a resin having a positive intrinsic birefringence, thereby preventing breakage of the layer made of a resin having a negative intrinsic birefringence.

However, such a phase difference film is required to have a thinner thickness as display devices become thinner. In order to obtain a phase difference film having a thin thickness, molecular chains in the phase difference film are usually required to be oriented to a large extent. However, when the degree of orientation is increased, the film is whitened in some cases. Such a whitened film cannot serve as an optical film. Especially, when a resin containing polycarbonate is used as the resin having a positive intrinsic birefringence, the whitening occurs easily, thereby making manufacture of the phase difference film difficult.

The present invention has been devised in view of the aforementioned problems, and has its object to provide a manufacturing method that enables easy manufacture of a phase difference film that has a thin thickness and in which retardation Re at an incident angle of 0° and retardation R₄₀ at an incident angle of 40° satisfy the relationship of 0.92≦R₄₀/Re≦1.08.

### Solution to Problem

The present inventor intensively conducted research in order to solve the aforementioned problems. As a result, the present inventor found out that the following manufacturing method enables easy manufacture, without causing whitening, of a phase difference film that has a thin thickness and in which the relationship of 0.92≦R₄₀/Re≦1.08 is satisfied. Thus, the present invention has been completed.

That is, the present invention is as follows.

(1) A method for manufacturing a phase difference film from a pre-stretch film, the pre-stretch film including a resin layer (a) made of a resin A containing polycarbonate, and a resin layer (b) provided on one surface of the resin layer (a) and made of a resin B having a negative intrinsic birefringence, the phase difference film including a resin layer A made of the resin A, and a resin layer B provided to one surface of the resin layer A and made of the resin B, wherein

retardation Re at an incident angle of 0° and retardation R₄₀ at an incident angle of 40° of the phase difference film satisfy a relationship of 0.92≦R₄₀/Re≦1.08,

the pre-stretch film is a film wherein, a phase of a linearly polarized light perpendicularly entering the film plane and having a vibration plane of an electric vector on an XZ plane relative to a linearly polarized light perpendicularly entering the film plane and having a vibration plane of an electric vector on a YZ plane delays when uniaxial stretching in an X-axis direction is performed at a temperature T1, and advances when uniaxial stretching in the X-axis direction is performed at a temperature T2 that is different from the temperature T1, provided that, in the pre-stretch film, the X-axis is the uniaxial stretching direction, the Y-axis is a direction orthogonal to the uniaxial stretching direction in a film plane, and the Z-axis is a film thickness direction,

the manufacturing method comprises a stretching step including a first stretching step of performing a uniaxial stretching treatment on the pre-stretch film in one direction at one of the temperatures T1 and T2, and a second stretching step of performing a uniaxial stretching treatment on the film in a direction orthogonal to the one direction of the uniaxial stretching treatment performed in the first stretching step at the other of the temperatures T1 and T2,

by the stretching step, the resin layer A having a plane orientation coefficient of more than 0.025 is obtained as a result of the stretching of the resin layer (a), and the resin layer B having a birefringence of 0.004 or more and an Nz coefficient of −0.30 or more is obtained as a result of the stretching of the resin layer (b),

the resin A has a glass transition temperature TgA of 147° C. or higher, and

the resin B has a glass transition temperature TgB that satisfies a relationship of TgA−TgB>20° C.

(2) The method for manufacturing a phase difference film according to (1), wherein the resin B contains a styrene-maleic anhydride copolymer.

(3) The method for manufacturing a phase difference film according to (1) or (2), comprising a step of performing a heat treatment at a temperature of TgB−30° C. or higher and TgB or lower, after the stretching step.

(4) The method for manufacturing a phase difference film according to any one of (1) to (3), wherein

the pre-stretch film further includes a resin layer (c) made of a resin C containing polycarbonate and provided on a surface opposite to the resin layer (a) of the resin layer (b),

the phase difference film further includes a resin layer C made of the resin C and provided on a surface opposite to the resin layer A of the resin layer B, and

by the stretching step, the resin layer C having a plane orientation coefficient of more than 0.025 is obtained as a result of the stretching of the resin layer (c).

(5) A phase difference film comprising: a resin layer A made of a resin A containing polycarbonate; and a resin layer B provided on one surface of the resin layer A and made of a resin B having a negative intrinsic birefringence, wherein

retardation Re at an incident angle of 0° and retardation R₄₀ at an incident angle of 40° satisfy a relationship of 0.92≦R₄₀/Re≦1.08,

the resin layer A has a plane orientation coefficient of more than 0.025,

the resin layer B has a birefringence of 0.004 or more and an Nz coefficient of −0.30 or more,

the resin A has a glass transition temperature TgA of 147° C. or higher, and

the resin B has a glass transition temperature TgB that satisfies a relationship of TgA−TgB>20° C.

(6) The phase difference film according to (5), wherein the resin B contains a styrene-maleic anhydride copolymer.

(7) The phase difference film according to (5) or (6), further comprising a resin layer C made of a resin C containing polycarbonate and provided on a surface opposite to the resin layer A of the resin layer B,

wherein the resin layer C has a plane orientation coefficient of more than 0.025.

### Advantageous Effects of Invention

According to the method for manufacturing a phase difference film of the present invention, a phase difference film that has a thin thickness and in which retardation Re at an incident angle of 0° and retardation R₄₀ at an incident angle of 40° satisfy the relationship of 0.92≦R₄₀/Re≦1.08 can be easily manufactured.

### BRIEF DESCRIPTION OF DRAWINGS

FIG. 1 is a diagram showing an example of temperature dependency of retardation Δ based on the stretching direction when a pre-stretch film is stretched, and temperature dependency of retardation Δ when each of a resin layer (a), a resin layer (b), and a resin layer (c) of the pre-stretch film is stretched.

### DESCRIPTION OF EMBODIMENTS

Although the present invention will be described in detail by referring to the following examples and embodiments, the present invention is not limited to the following examples and embodiments, which may be optionally modified for implementation within the scope not departing from the claims of the present invention and their equivalents.

In the following description, a positive intrinsic birefringence means, unless otherwise stated, that a refractive index in a stretching direction is larger than a refractive index in a direction orthogonal to the stretching direction. Furthermore, a negative intrinsic birefringence means, unless otherwise stated, that a refractive index in a stretching direction is smaller than a refractive index in a direction orthogonal to the stretching direction. The value of the intrinsic birefringence may be calculated from a permittivity distribution.

As described herein, retardation is a value represented by “(nx−ny)×d”, unless otherwise stated. A plane orientation coefficient is a value represented by “(nx+ny)/2−nz”, unless otherwise stated. Birefringence is a value represented by “nx−ny”, unless otherwise stated. An Nz coefficient is a value represented by “(nx−nz)/(nx−ny)”, unless otherwise stated. Here, nx represents a refractive index in a direction (an in-plane direction) that is perpendicular to a thickness direction and that provides a maximum refractive index; ny represents a refractive index in a direction that is in the in-plane direction and that is perpendicular to the direction of nx; nz represents a refractive index in a thickness direction; and d represents a thickness. Unless otherwise stated, the measurement wavelength for these refractive indices nx, ny, and nz is 532 nm.

Unless otherwise stated, a slow axis of a film or a layer represents a slow axis in a plane.

The “polarizing plate” includes not only a rigid member but also a flexible member such as a resin film.

The direction of a constituent being “parallel”, “perpendicular” or “orthogonal” may include, unless otherwise stated, an error within the range that does not impair the effect of the present invention, for example, within the range of usually ±5°, preferably ±2°, and more preferably ±1°.

The MD direction (machine direction) is a flow direction of a film in a manufacturing line, and usually coincides with a lengthwise direction and a longitudinal direction of a long-length film. The TD direction (traverse direction) is a direction that is parallel to a film plane and perpendicular to the MD direction, and usually coincides with a width direction and a crosswise direction of a long-length film. The term “long-length” refers to those having a length that is not less than 5 times the width, and preferably not less than 10 times the width, and specifically those having a length to a degree that allows for winding into a roll shape for storage or transportation.

[1. Outline]

The method for manufacturing the phase difference film according to the present invention is a method for manufacturing a phase difference film that satisfies a relationship of 0.92≦R₄₀/Re≦1.08. Here, Re represents retardation at an incident angle of 0° of the phase difference film. R₄₀ represents retardation at an incident angle of 40° of the phase difference film. In this manufacturing method, a pre-stretch film including a resin layer (a) and a resin layer (b) provided on one surface of the resin layer (a) is used to manufacture a phase difference film including a resin layer A and a resin layer B provided on one surface of the resin layer A. The pre-stretch film may further include, other than the resin layer (a) and the resin layer (b), a resin layer (c) provided on a surface opposite to the resin layer (a) of the resin layer (b). The pre-stretch film including such a resin layer (c) is usually used to obtain a phase difference film including a resin layer C provided on a surface opposite to the resin layer A of the resin layer B.

When the pre-stretch film is stretched in different directions orthogonal to each other at different temperatures of temperatures T1 and T2, the resin layers of the pre-stretch film can each develop different optical properties corresponding to the stretching conditions such as temperatures T1 and T2, a stretching factor, and a stretching direction. The different optical properties developed in the respective resin layers are synthesized in the phase difference film obtained from the aforementioned pre-stretch film. Therefore, the phase difference film having desired optical properties can be obtained by the manufacturing method according to the present invention.

[2. Resin]

<2.1. Resin A>

The resin layer (a) of the pre-stretch film is made of a resin A. The resin layer A of the phase difference film is obtained from the resin layer (a) of the pre-stretch film, and is therefore a layer made of the resin A that is the same as the resin layer (a). As this resin A, a polycarbonate-containing resin is used. Polycarbonate is a polymer that is excellent in retardation expression properties, stretching properties at low temperatures, and adhesion properties with other layers.

As polycarbonate, a polymer having a structural unit containing a carbonate bond (—O—C(═O)—O—) may be used. Polycarbonate may contain one type of structural unit, or may contain two or more types of structural units combined at any ratio.

Examples of polycarbonate may include bisphenol A polycarbonate, branched bisphenol A polycarbonate, and o,o,o′,o′-tetramethyl bisphenol A polycarbonate. As the polycarbonate, one type thereof may be used alone, or two or more types thereof may be used in combination at any ratio.

The ratio of polycarbonate in the resin A is preferably 50% by weight to 100% by weight, and more preferably 70% by weight to 100% by weight.

The resin A may contain a component other than polycarbonate, as long as the effects of the present invention are not significantly impaired. For example, the resin A may contain a polymer other than polycarbonate, a compounding agent, and the like.

Examples of the polymer other than polycarbonate that may be contained in the resin A may include an acrylic polymer such as polymethyl methacrylate; an olefin polymer such as polyethylene and polypropylene; a polyester such as polyethylene terephthalate and polybutylene terephthalate; a polyarylene sulfide such as polyphenylene sulfide; polyvinyl alcohol; a cellulose ester; polyether sulfone; a polysulfone; a polyallyl sulfone; a polyvinyl chloride; a norbornene polymer; and a rod-like liquid crystal polymer. A component of each of these polymers may be contained as a structural unit in part of polycarbonate. Furthermore, one type of these may be used alone, or two or more types thereof may be used in combination at any ratio.

However, the amount of the polymer other than polycarbonate in the resin A is preferably small from the viewpoint of significantly exerting the advantages of the present invention. Specifically, the amount of the polymer other than polycarbonate with respect to 100 parts by weight of polycarbonate is preferably 10 parts by weight or less, more preferably 5 parts by weight or less, and further preferably 3 parts by weight or less. Especially, it is particularly preferred not to contain the polymer other than polycarbonate.

The resin A preferably has a positive intrinsic birefringence. Therefore, the polymer other than polycarbonate is preferably a polymer having a positive intrinsic birefringence.

Examples of the compounding agent that may be contained in the resin A may include a lubricant; a layered crystalline compound; an inorganic fine particle; a stabilizer such as an antioxidant, a thermal stabilizer, a light stabilizer, a weathering stabilizer, and an ultraviolet absorber; an infrared ray absorber; a plasticizer; a coloring agent such as a dye and a pigment; and an antistatic agent. Among these, the lubricant and the ultraviolet absorber can improve flexibility and weather resistance, and are therefore preferable. As the compounding agent, one type thereof may be used alone, or two or more types thereof may be used in combination at any ratio.

Examples of the lubricant may include an inorganic particle such as silicon dioxide, titanium dioxide, magnesium oxide, calcium carbonate, magnesium carbonate, barium sulfate, and strontium sulfate; and an organic particle such as polymethyl acrylate, polymethyl methacrylate, polyacrylonitrile, polystyrene, cellulose acetate, and cellulose acetate propionate. Especially, the organic particle is preferable as the lubricant.

Examples of the ultraviolet absorber may include an oxybenzophenone-based compound, a benzotriazole-based compound, a salicylic acid ester-based compound, a benzophenone-based ultraviolet absorber, a benzotriazole-based ultraviolet absorber, an acrylonitrile-based ultraviolet absorber, a triazine-based compound, a nickel complex salt-based compound, and an inorganic powder. Specific examples of a suitable ultraviolet absorber may include 2,2′-methylenebis(4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, 2,4-di-tert-butyl-6-(5-chlorobenzotriazole-2-yl)phenol, 2,2′-dihydroxy-4,4′-dimethoxybenzophenone, and 2,2′,4,4′-tetrahydroxybenzophenone. Among these, 2,2′-methylenebis(4-(1,1,3,3-tetramethylbutyl)-6-(2H-benzotriazole-2-yl)phenol) is particularly preferable.

The amount of the compounding agent may be appropriately determined within the range that does not impair significantly the effects of the present invention. For example, the amount of the compounding agent may be set within the range that can maintain 80% or more and 100% or less of a total light transmittance of the phase difference film in terms of 1 mm in thickness.

The glass transition temperature TgA of the resin A is usually 147° C. or higher, and preferably 150° C. or higher. By setting the glass transition temperature TgA high in this manner, a molecular chain contained in the resin A can be oriented to a large extent, thereby enabling manufacture of a phase difference film having a thin thickness. Furthermore, orientation relaxation of the resin A can be reduced. The upper limit of the glass transition temperature TgA of the resin A is not particularly limited, but usually 200° C. or lower.

The rupture elongation of the resin A at the glass transition temperature TgB of a resin B is preferably 50% or more, and more preferably 80% or more. The upper limit of the rupture elongation of the resin A is not particularly limited, but usually 200% or less. When the rupture elongation falls within this range, the phase difference film can be stably prepared by stretching. Here, the rupture elongation may be calculated using test piece type 1B described in JIS K 7127 as a test piece at a pulling rate of 100 mm/min.

<2.2. Resin B>

The resin layer (b) of the pre-stretch film is made of a resin B. The resin layer B of the phase difference film is obtained from the resin layer (b) of the pre-stretch film, and is therefore a layer made of the resin B that is the same as the resin layer (b). As this resin B, a resin having a negative intrinsic birefringence is used.

The resin B is preferably a thermoplastic resin. Examples of a polymer contained in the resin B may include a polystyrene-based polymer such as a homopolymer of styrene or a styrene derivative, and a copolymer of styrene or a styrene derivative and an optional monomer; a polyacrylonitrile polymer; a polymethyl methacrylate polymer; and a multicomponent copolymer thereof. Examples of the preferred optional monomer to be copolymerized with styrene or a styrene derivative may include acrylonitrile, maleic anhydride, methyl methacrylate, and butadiene. As the polymers, one type thereof may be used alone, or two or more types thereof may be used in combination at any ratio. Among these, the polystyrene-based polymer is preferable from the viewpoint of high retardation expression properties.

Furthermore, in terms of high heat resistance, the copolymer of styrene or a styrene derivative and maleic anhydride is more preferable, and the styrene-maleic anhydride copolymer is particularly preferable. In this case, the amount of a structural unit having a structure formed by polymerizing maleic anhydride, with respect to 100 parts by weight of the polystyrene-based polymer, is preferably 5 parts by weight or more, more preferably 10 parts by weight or more, and particularly preferably 15 parts by weight or more, and is preferably 30 parts by weight or less, more preferably 28 parts by weight or less, and particularly preferably 26 parts by weight or less.

The ratio of the polymer in the resin B is preferably 50% by weight to 100% by weight, and more preferably 70% by weight to 100% by weight.

The resin B may contain a compounding agent. Examples thereof may be the same as those described as examples of the compounding agent that may be contained in the resin A. As the compounding agent, one type thereof may be used alone, or two or more types thereof may be used in combination at any ratio.

The amount of the compounding agent may be appropriately determined within the range that does not impair significantly the effects of the present invention. For example, the amount of the compounding agent may be set within the range that can maintain 80% or more and 100% or less of a total light transmittance of the phase difference film having a thickness of 1 mm.

The glass transition temperature TgB of the resin B is set such that a difference TgA−TgB between the glass transition temperature TgA of the resin A and the glass transition temperature TgB of the resin B satisfies a relationship of TgA−TgB>20° C. More specifically, TgA−TgB is set to be usually more than 20° C., and preferably more than 22° C. This can increase temperature dependency of retardation expression during stretching of the pre-stretch film. Furthermore, such a difference in temperature also enables molecular chains contained in the resin layer A and the resin layer B to be oriented to a large extent by stretching. For this reason, the thickness of the phase difference film can be reduced. The upper limit of TgA−TgB is preferably 50° C. or less, more preferably 40° C. or less, and particularly preferably 30° C. or less. Thereby, the phase difference film may have good planarity easily.

The glass transition temperature TgB of the resin B is usually 80° C. or higher, preferably 90° C. or higher, more preferably 100° C. or higher, further preferably 110° C. or higher, and particularly preferably 120° C. or higher. With such a high glass transition temperature TgB, orientation relaxation of the resin B can be reduced. The upper limit of the glass transition temperature TgB of the resin B is not particularly limited, but usually 200° C. or lower.

The rupture elongation of the resin B at the glass transition temperature TgA of the resin A is preferably 50% or more, and more preferably 80% or more. The upper limit of the rupture elongation of the resin B is not particularly limited, but usually 200% or less. When the rupture elongation falls within this range, the phase difference film can be stably prepared by stretching. Here, the rupture elongation may be calculated using test piece type 1B described in JIS K 7127 as a test piece at a pulling rate of 100 mm/min.

<2.3. Resin C>

The resin layer (c) of the pre-stretch film is made of a resin C. The resin layer C of the phase difference film is obtained from the resin layer (c) of the pre-stretch film, and is therefore a layer made of the resin C that is the same as the resin layer (c). As this resin C, a resin selected from the range that is the same as the aforementioned range for the resin A may be usually used. Accordingly, for example, the type and amount of the polymer and the compounding agent that may be contained in the resin C as well as the glass transition temperature of the resin C may be selected from ranges that is the same as the ranges for the resin A.

The polymers of the resin A and the resin C may have the same or different composition, but preferably have the same composition. When the polymers of the resin A and the resin C have the same composition, bending and warping of the pre-stretch film and the phase difference film can be suppressed. Furthermore, the plane orientation coefficients of the resin layer A and the resin layer C of the obtained phase difference film can be easily controlled. The resin A and the resin C may have the exactly same composition, but may also have a structure in which the same polymer is used and only the compounding agent added to the polymer may be different.

[3. Pre-Stretch Film]

The pre-stretch film includes the resin layer (a), and the resin layer (b) provided on one surface of the resin layer (a). The resin layer (c) may be further provided on a surface opposite to the resin layer (a) of the resin layer (b). That is, the pre-stretch film may be a multilayer film including the resin layer (a), the resin layer (b), and the resin layer (c) in this order. Usually, the layer (a) and the layer (b) are in direct contact with each other without another layer interposed therebetween, and the layer (b) and the layer (c) are in direct contact with each other without another layer interposed therebetween.

The pre-stretch film may include two or more resin layers (a), two or more resin layers (b), and two or more resin layers (c). However, from the viewpoint of simplifying control of retardation and reducing the thickness of the phase difference film, the pre-stretch film preferably includes only one resin layer (a), one resin layer (b), and one resin layer (c).

In the manufacturing method of the present invention, a phase of a linearly polarized light perpendicularly entering the film plane and having a vibration plane of an electric vector on an XZ plane relative to a linearly polarized light perpendicularly entering the film plane and having a vibration plane of an electric vector on a YZ plane:

delays when uniaxial stretching in the X-axis direction is performed at a temperature T1, and

advances when uniaxial stretching in the X-axis direction is performed at a temperature T2 that is different from the temperature T1, provided that, in the pre-stretch film, the X-axis is the uniaxial stretching direction, the Y-axis is a direction orthogonal to the uniaxial stretching direction in the film plane, and the Z-axis is a film thickness direction. Hereinafter, the linearly polarized light perpendicularly entering the film plane and having a vibration plane of an electric vector on the XZ plane may be appropriately referred to as “XZ polarization”, and the linearly polarized light perpendicularly entering the film plane and having a vibration plane of an electric vector on the YZ plane may be appropriately referred to as “YZ polarization”. Furthermore, the aforementioned requirement of the pre-stretch film where the phase of the XZ polarization relative to the YZ polarization delays when uniaxial stretching in the X-axis direction is performed at the temperature T1 and advances when uniaxial stretching in the X-axis direction is performed at the temperature T2 that is different from the temperature T1 may be appropriately referred to as “requirement P”.

The aforementioned requirement P is set to be satisfied when at least one direction of various directions in the plane of the pre-stretch film is the X-axis. Usually, the pre-stretch film is an isotropic raw material film. That is, the pre-stretch film is usually a raw material film that does not have anisotropy. Therefore, if the requirement P is satisfied when one direction in the plane is the X-axis, the pre-stretch film can also satisfy the requirement P when any other direction is defined as the X-axis.

In a film having an in-plane slow axis appearing in the X-axis by uniaxial stretching, the phase of XZ polarization usually delays relative to that of YZ polarization. Conversely, in a film having a fast axis appearing in the X-axis by uniaxial stretching, the phase of XZ polarization advances relative to that of YZ polarization. The pre-stretch film satisfying the aforementioned requirement P is a multilayer film taking advantage of these properties, and is also a film whose manner of having a slow axis or a fast axis depends on a stretching temperature. Such temperature dependency of retardation expression may be adjusted by, for example, adjusting a relationship such as the photoelastic coefficients of the resins contained in the pre-stretch film as well as the thickness ratio among the layers.

Here, the conditions to be satisfied by the pre-stretch film will be described referring to an example of retardation Δ based on a stretching direction. Retardation Δ based on a stretching direction is defined as a value obtained by multiplying a difference (=nX— nY) between a refractive index nX in the X-axis direction as a stretching direction and a refractive index nY in the Y-axis direction as a direction orthogonal to the stretching direction in a plane, by a thickness d. At this time, retardation Δ that can be expressed in the entire the pre-stretch film when the pre-stretch film is stretched is synthesized from retardation Δ that is expressed in each resin layer contained in the pre-stretch film. Therefore, it is preferable to adjust the thickness of each layer contained in the pre-stretch film so as to satisfy the following conditions (I) and (II) in order that, for example, the sign of retardation Δ expressed when the pre-stretch film is stretched becomes in reverse between stretching at a high temperature T1 and stretching at a low temperature T2.

(I) In stretching at the low temperature T_{L}, the absolute value of retardation Δ expressed by a resin having a high glass transition temperature is smaller than the absolute value of retardation Δ expressed by a resin having a low glass transition temperature.

(II) In stretching at the high temperature T_{H}, the absolute value of retardation Δ expressed by a resin having a low glass transition temperature is smaller than the absolute value of retardation Δ expressed by a resin having a high glass transition temperature.

The temperature T1 is one of the temperatures T_{H} and T_{L}, and the temperature T2 is the other of the temperatures T_{H} and T_{L}. The temperature satisfying the aforementioned requirement P is preferably (Tg₁−10° C.) to (Tgₕ+10° C.), because expression of birefringence is easily adjusted. That is, the temperatures T1 and T2 preferably fall within the temperature range of (Tg₁−10° C.) to (Tgₕ+10° C.). Here, the temperature Tg₁ means the glass transition temperature of a resin having the lowest glass transition temperature among the resins A to C contained in the pre-stretch film. The temperature Tgₕ means the glass transition temperature of a resin having the highest glass transition temperature among the resins A to C contained in the pre-stretch film.

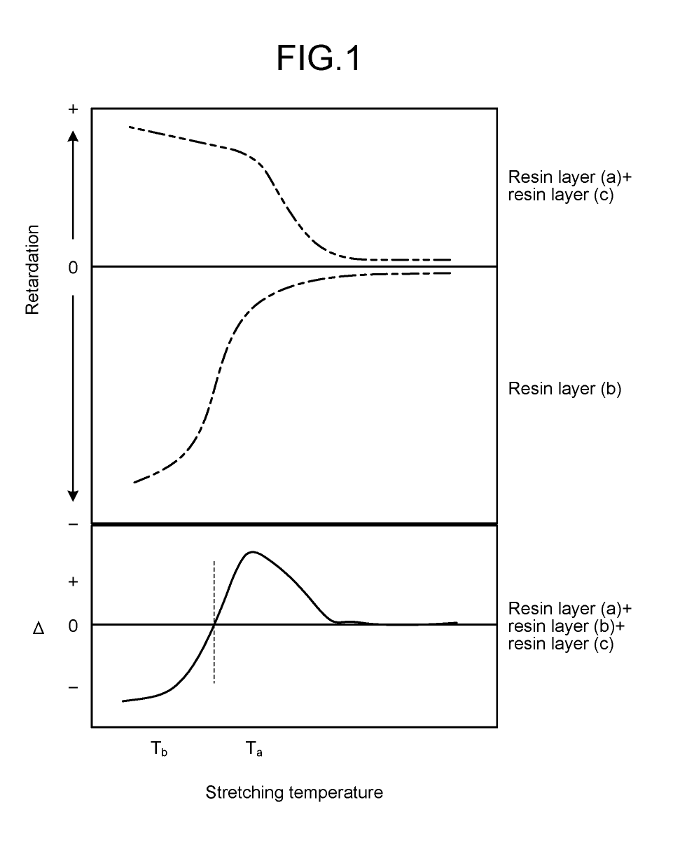

Expression of retardation Δ when the pre-stretch film satisfying the requirement P is stretched will be specifically described with reference to the drawing. FIG. 1 is a diagram showing an example of temperature dependency of retardation Δ when the pre-stretch film is stretched, and temperature dependency of retardation Δ when each of the resin layer (a), the resin layer (b), and the resin layer (c) of the pre-stretch film is stretched. In the example shown in FIG. 1, the resin A and the resin C are the same resin; the resin A and the resin C has a high glass transition temperature; and the resin B has a low glass transition temperature.

In the pre-stretch film shown in FIG. 1, minus retardation Δ expressed in the resin layer (b) is larger than plus retardation Δ expressed in the resin layer (a) and the resin layer (c) during stretching at a low temperature Tb, such that minus retardation Δ is expressed by the entire film. On the other hand, minus retardation Δ expressed in the resin layer (b) is smaller than plus retardation Δ expressed in the resin layer (a) and the resin layer (c) during stretching at a high temperature Ta, such that plus retardation Δ is expressed by the entire film. Thus, combination of stretching at such different temperatures Ta and Tb allows for synthesis of retardations Δ generated during stretching at each of the temperatures. Accordingly, there can be stably achieved a phase difference film having desired retardation Δ and also indicating desired optical properties.

In this manner, the pre-stretch film satisfying the aforementioned requirement P may be obtained by: selecting as resins constituting the aforementioned resin layers a combination of resins each capable of generating a difference in refractive index between the X-axis direction and the Y-axis direction in each resin layer by stretching in one direction (that is, uniaxial stretching); and also adjusting the total thickness of the resin layers in consideration of the stretching conditions. At this time, the degree of orientation expressed by stretching is large in the resin A and the resin B used in the manufacturing method of the present invention. That is, the resin A and the resin B have a large orientation degree expressed per stretching factor. For this reason, even when the thickness of the resin layers contained in the pre-stretch film is reduced, there can be expressed retardation Δ to a degree equivalent to that of a known phase difference film.

The specific thickness of each of the resin layers constituting the pre-stretch film may be set according to the optical properties of a desired phase difference film in order to satisfy the aforementioned requirement P. At this time, a ratio TA/TB between a total thickness TA of the resin layer (a) and the resin layer (c) and a total thickness TB of the resin layer (b) is preferably ¼ or less, and more preferably ⅕ or less, and is preferably 1/20 or more, and more preferably 1/15 or more. Accordingly, temperature dependency of retardation expression can be increased.

The total thickness of the pre-stretch film is preferably 10 μm or more, more preferably 20 μm or more, and particularly preferably 30 μm or more, and is preferably 500 μm or less, more preferably 400 μm or less, and particularly preferably 300 μm or less. When the total thickness of the pre-stretch film is not less than the lower limit value of the aforementioned range, the phase difference film having sufficient retardation is easily manufactured, and the obtained phase difference film can have high mechanical strength. When the total thickness thereof is not more than the upper limit value, the pre-stretch film can have higher flexibility and favorable handleability.

When the pre-stretch film includes the resin layer (c), any one of the resin layer (a) and the resin layer (c) may be thicker than the other. However, the thickness of the thick resin layer is preferably not less than 1.5 times the thickness of the thin resin layer, from the viewpoint of compensating light leakage of a polarizer when the phase difference film is combined with the polarizer in a liquid crystal display device. Furthermore, the thickness of the thick resin layer is preferably not more than 10 times the thickness of the thin resin layer, from the viewpoint of maintaining the accuracy in thickness of the thin resin layer.

Fluctuation in thickness of each resin layer of the pre-stretch film is preferably 1 μm or less in the entire surface. As described herein, fluctuation in thickness of a resin layer indicate a difference in thickness of a resin layer between the maximum value and the minimum value. This can confine the fluctuation in thickness to be 1 μm or less in the entire surface in each resin layer of the phase difference film, thereby enabling reduction of fluctuation in color tone of a display device provided with the phase difference film. Furthermore, changes in color tone after long usage of the phase difference film can become uniform.

For example, the following (i) to (vi) may be performed so that fluctuation in thickness of each layer becomes 1 μm or less in the entire surface as described above.

(i) Providing a polymer filter having an opening of 20 μm or less in an extruder.

(ii) Rotating a gear pump at 5 rpm or more.

(iii) Disposing an enclosing unit around a die.

(iv) Providing an air gap of 200 mm or shorter.

(v) Performing edge pinning when casting a film on a cooling roll.

(vi) Using, as an extruder, a biaxial extruder, or a uniaxial extruder having a double flight-type screw system.

The method for manufacturing the pre-stretch film is not limited. The pre-stretch film may be manufactured by, for example, a coextrusion method; a film lamination molding method such as dry lamination; a cocasting method; and a coating molding method such as coating a resin film surface with a resin solution. Among these, the coextrusion method is preferable, from the viewpoint of manufacturing efficiency and prevention of volatile components such as a solvent from remaining in the film.

When the coextrusion method is adopted, the pre-stretch film is subjected to, for example, a coextrusion step of coextruding the resin A and the resin B, as well as the resin C used as necessary. Examples of the coextrusion method may include a coextrusion T die method, a coextrusion inflation method, and a coextrusion lamination method. Among these, the coextrusion T die method is preferable. The coextrusion T die method is classified into a method of feedblock type and a method of multimanifold type, and the multimanifold type is particularly preferable since fluctuation in thickness can be reduced.

When the coextrusion T die method is adopted, the melting temperature of resin in an extruder having a T die is preferably TG+80° C. or higher, and more preferably TG+100° C. or higher, and is preferably TG+180° C. or lower, and more preferably TG+150° C. or lower. Here, TG represents the glass transition temperature of the resin used. When the melting temperature of the resin in the extruder is set to be not less than the lower limit value of the aforementioned range, the resin can have sufficiently increased fluidity. When the melting temperature is set to be not more than the upper limit value, deterioration of the resin can be prevented.

In the coextrusion method, a film-like melted resin extruded from an opening of a die usually adheres to a cooling roll (also referred to as a cooling drum). Examples of the method for allowing a melted resin to adhere to a cooling roll may include an air knife procedure, a vacuum box procedure, and an electrostatic adhesion procedure.

The number of the cooling rolls is not particularly limited, but is usually two or more. Examples of the arrangement of the cooling rolls may include, but not be particularly limited to, straight line-type, Z-type, and L-type. The method of passing the melted resin extruded from an opening of a die through a gap between the cooling rolls is also not particularly limited.

The adhesion degree of the extruded film-like resin to the cooling roll usually varies depending on the temperature of the cooling roll. As the temperature of the cooling roll increases, adhesion tends to become favorable. Furthermore, when the temperature of the cooling roll is controlled not to become excessively high, the film-like resin can be easily peeled off from the cooling roll, thereby preventing the resin from winding around the cooling roll. From the viewpoint as described above, when Tg is the glass transition temperature of a resin of the layer to be extruded from a die and brought into contact with a drum, the temperature of the cooling roll is preferably (Tg+30° C.) or lower, and further preferably in the range of (Tg−5° C.) to (Tg−45° C.). Accordingly, failures such as slipping and flaws can be prevented.

The content of the residual solvent in the pre-stretch film is preferably made low. Examples of the measures for lowering the solvent content may include: (1) reducing a residual solvent contained in a resin as a raw material; and (2) preliminarily drying the resin prior to molding of the pre-stretch film. Preliminary drying is performed by, for example, transforming a resin into pellets and using a hot air dryer. The drying temperature is preferably 100° C. or higher, and the drying time is preferably two hours or longer. Performing the preliminary drying can reduce the residual solvent in the pre-stretch film, and furthermore can prevent foaming of the extruded film-like resin.

[4. Stretching Step]

The method for manufacturing the phase difference film according to the present invention includes a stretching step of subjecting the aforementioned pre-stretch film to a stretching treatment. When the pre-stretch film is stretched in this stretching step, each resin layer contained in the pre-stretch film is also stretched, so that specific optical properties are expressed in each of the stretched resin layers.

The stretching step includes: a first stretching step of performing a uniaxial stretching treatment on a pre-stretch film in one direction at one of the temperatures T1 and T2; and a second stretching step of performing a uniaxial stretching treatment on the film in a direction orthogonal to the direction of the uniaxial stretching treatment performed in the first stretching step at the other of the temperatures T1 and T2.

<4.1. First Stretching Step>

In the first stretching step, a uniaxial stretching treatment is performed on a pre-stretch film in one direction at one of the temperatures T1 and T2. In the pre-stretch film satisfying requirement P, stretching at the temperature T1 causes a delay of the phase of XZ polarization relative to YZ polarization. On the other hand, uniaxial stretching at the temperature T2 causes an advance of the phase of XZ polarization relative to YZ polarization. Especially, a uniaxial stretching treatment is preferably performed at the temperature T1 in the first stretching step.

The temperature T1 is preferably higher than TgB, and more preferably higher than (TgB+5° C.), and is preferably lower than (TgA+40° C.), and more preferably lower than (TgA+20° C.). When the temperature T1 is set to be higher than the lower limit of the aforementioned range, the resin layer B can have optical properties that stably fall within a desired range. Furthermore, when the temperature T1 is set to be lower than the upper limit of the aforementioned range, the resin layer A can have optical properties that stably fall within a desired range.

In addition, as the stretching temperature is lower, the obtained phase difference film tends to have a larger plane orientation coefficient. Therefore, the temperature T1 is preferably lower within the range that allows desired optical properties to be stably expressed in the phase difference film.

The stretching factor in the first stretching step is preferably twice or more, and more preferably three times or more, and is preferably four times or less, and more preferably 3.5 times or less. When the stretching factor in the first stretching step is set to be not less than the lower limit value of the aforementioned range, molecules contained in the resin layer can be oriented to a large extent, thereby enabling expression of desired optical properties with a thin thickness. When the stretching factor is set to be not more than the upper limit value, the phase difference film can be stably manufactured.

The uniaxial stretching treatment may be performed by known methods. Examples of such methods may include a method of performing uniaxial stretching in an MD direction by taking advantage of a difference in peripheral speed between rolls; and a method of performing uniaxial stretching in a TD direction using a tenter. Examples of the method of performing uniaxial stretching in an MD direction may include IR heating between rolls, and a float procedure. Among them, the float procedure is suitable to obtain the phase difference film having high optical uniformity. On the other hand, an example of the method of performing uniaxial stretching in a TD direction may include a tenter method.

In the uniaxial stretching treatment, differences in temperature may be provided in the TD direction of the pre-stretch film in a stretching zone in order to reduce stretching unevenness and thickness unevenness. In the stretching zone, the differences in temperature may be provided in the TD direction by, for example, adjusting an opening degree of a hot air nozzle in the TD direction, or aligning IR heaters in the TD direction to control heating.

<4.2. Second Stretching Step>

The first stretching step is followed by the second stretching step. In the second stretching step, the film that has been subjected to the uniaxial stretching treatment in one direction in the first stretching step is subjected to a uniaxial stretching treatment in a direction orthogonal to the direction of the uniaxial stretching treatment performed in the first stretching step.

The uniaxial stretching treatment in the second stretching step is performed at a temperature that is one of the temperatures T1 and T2 that is different from the stretching temperature in the first stretching step. In this second stretching step, the uniaxial stretching treatment is preferably performed at the temperature T2.

The temperature T2 is usually a temperature that is lower than the temperature T1. Specifically, the temperature T2 is preferably higher than (TgB−20° C.), and more preferably higher than (TgB−10° C.), and is preferably lower than (TgB+5° C.), and preferably lower than TgB. When the temperature T2 is set to be higher than the lower limit of the aforementioned range, the film can be prevented from rupturing and clouding in white during stretching. When the temperature T2 is set to be lower than the upper limit of the aforementioned range, desired optical properties can be stably expressed in the resin layer B. In this manner, even when stretching is performed at a temperature that is substantially lower than the glass transition temperature TgA of the resin A, whitening does not occur in the resin layer A. This is one of the advantages of the present invention.

In addition, as the stretching temperature is lower, the obtained phase difference film tends to have a larger plane orientation coefficient. Therefore, the temperature T2 is preferably lower within the range that allows desired optical properties to be stably expressed in the phase difference film.

The difference between the temperature T1 and the temperature T2 is usually 10° C. or more, and preferably 20° C. or more. When the difference between the temperature T1 and the temperature T2 is set to be large as described above, desired optical properties can be stably expressed in the phase difference film. The upper limit of the difference between the temperature T1 and the temperature T2 is not limited, but preferably 100° C. or lower from the viewpoint of industrial productivity.

The stretching factor in the second stretching step is preferably smaller than the stretching factor in the first stretching step. In the sequential stretching steps, the molecular orientation state in the obtained phase difference film is influenced more strongly by the second stretching step than by the first stretching step. Therefore, the smaller the stretching factor in the second stretching step is, the easier adjustment of the optical properties of the phase difference film is. Specifically, the stretching factor in the second stretching step is preferably 1.1 times or more, and is preferably twice or less, more preferably 1.5 times or less, and particularly preferably 1.3 time or less.

Furthermore, from the viewpoint of obtaining a high plane orientation coefficient, the stretching factor is preferably high both in the first stretching step and the second stretching step. Specifically, the product of the stretching factors in the first stretching step and the second stretching step is preferably 3.6 or more, more preferably 3.8 or more, and further preferably 4.0 or more. The upper limit of the product of the stretching factor in the first stretching step and the stretching factor in the second stretching step is preferably 6.0 or less, from the viewpoint of facilitating adjustment of optical properties in the stretching step.

The uniaxial stretching treatment in the second stretching step may be the same as the method that may be adopted in the uniaxial stretching treatment in the first stretching step.

The combination of the stretching directions in the first stretching step and the second stretching step may be any combination. For example, stretching may be performed in the MD direction in the first stretching step, and in the TD direction in the second stretching step. Alternatively, for example, stretching may be performed in the TD direction in the first stretching step, and in the MD direction in the second stretching step. Furthermore, for example, stretching may be performed in one oblique direction in the first stretching step, and in another oblique direction, orthogonal to the one oblique direction of the first stretching step, in the second stretching step. Here, the oblique direction indicates a direction that is neither parallel nor orthogonal to the width direction of the film. Among these, it is preferable to stretch in the TD direction in the first stretching step, and stretch in the MD direction in the second stretching step. When stretching in the second stretching step in which the stretching factor is small is performed in the MD direction, fluctuation of the optical axis direction can be reduced over the entire width of the obtained phase difference film.

<4.3. Optical Properties Expressed by Stretching Step>

By the aforementioned stretching step, the resin layer (a) is stretched thereby to obtain the resin layer A, and the resin layer (b) is stretched thereby to obtain the resin layer B. When the pre-stretch film includes the resin layer (c), the resin layer (c) is stretched thereby to obtain the resin layer C by the aforementioned stretching step. Molecules contained in the resin layer (a), the resin layer (b), and the resin layer (c) are oriented by the stretching treatment in the stretching step. Therefore, the resin layer A, the resin layer B, and the resin layer C obtained by the stretching step have desired optical properties. Such optical properties include a plane orientation coefficient, birefringence, and an Nz coefficient.

The resin layer A obtained by the stretching step has a plane orientation coefficient of usually more than 0.025, and preferably 0.026 or more, and of usually 0.035 or less, and preferably 0.030 or less. When the plane orientation coefficient of the resin layer A is set to be not less than the lower limit value of the aforementioned range, the thickness of the phase difference film can be reduced within the range that enables the phase difference film to satisfy the relationship of 0.92≦R₄₀/Re≦1.08. When the plane orientation coefficient is set to be not more than the upper limit value, the phase difference film can be stably manufactured.

The plane orientation coefficient of the resin layer B obtained by the stretching step is preferably as low as possible, usually −0.002 or less, and preferably −0.003 or less. When the plane orientation coefficient of the resin layer B is set to fall within the aforementioned range, the thickness of the phase difference film can be reduced. The lower limit value thereof is usually −0.008 or more, from the viewpoint of industrial productivity.

The plane orientation coefficient of the resin layer C obtained by the stretching step preferably falls within a range that is the same as the range that has been described as the range of the plane orientation coefficient for the resin layer A, from a viewpoint similar to the resin layer A.

The plane orientation coefficient is an index indicating the orientation state of a molecular chain in a layer. Specifically, in the layer of a resin having a positive intrinsic birefringence, a larger plane orientation coefficient usually indicates higher degree of orthogonal molecule orientation with respect to the thickness direction of the layer. In the layer of a resin having a negative intrinsic birefringence, a smaller plane orientation coefficient usually indicates higher degree of orthogonal molecule orientation with respect to the thickness direction of the layer.

When the pre-stretch film is an isotropic raw material film, the resin layer (a), the resin layer (b), and the resin layer (c) contained in the pre-stretch film each have a refractive index without anisotropy, such that the plane orientation coefficient is almost zero. In this case, the aforementioned plane orientation coefficients possessed by the resin layer A, the resin layer B, and the resin layer C obtained by the stretching step are the plane orientation coefficients expressed by the stretching treatment in the stretching step.

When attempting to express such a large plane orientation coefficient, the orientation degree is required to be increased. It has been considered that this may cause whitening in the resin layer. Especially, since the resin A containing polycarbonate is easy to cause whitening, an increased orientation degree in an attempt to express a large plane orientation coefficient has been considered to have particularly high likelihood to cause whitening. However, in the method for manufacturing the phase difference film according to the present invention, combination of the resin and the stretching conditions as described above enables expression of a high plane orientation coefficient without causing whitening in the stretching step.

The birefringence of the resin layer A obtained by the stretching step is preferably as high as possible, usually 0.002 or more, and preferably 0.004 or more. When the birefringence of the resin layer A is set to fall within the aforementioned range, fluctuation of the slow axis of the resin layer A can be suppressed to be small. The upper limit value is usually 0.020 or less, from the viewpoint of industrial productivity.

The birefringence of the resin layer B obtained by the stretching step is usually 0.004 or more, and preferably 0.005 or more, and is usually 0.010 or less, and preferably 0.008 or less. When the birefringence of the resin layer B is set to be not less than the lower limit value of the aforementioned range, the thickness of the phase difference film can be reduced within the range that enables the phase difference film to satisfy the relationship of 0.92≦R₄₀/Re≦1.08. When the birefringence is set to be not more than the upper limit value, the phase difference film can be stably manufactured.

The birefringence of the resin layer C obtained by the stretching step preferably falls within a range that is the same as the range that has been described as the range of the birefringence for the resin layer A, from a viewpoint similar to the resin layer A.

When the pre-stretch film is an isotropic raw material film, the birefringence thereof is almost zero. In this case, the aforementioned birefringences possessed by the resin layer A, the resin layer B, and the resin layer C obtained by the stretching step are the birefringences expressed by the stretching treatment in the stretching step.

The Nz coefficient of the resin layer A obtained by the stretching step is preferably as low as possible, usually 10 or less, and preferably 5 or less. When the Nz coefficient of the resin layer A is set to fall within the aforementioned range, fluctuation of the slow axis of the resin layer A can be suppressed to be small. The lower limit value thereof is theoretically 1, but usually 1.5 or more from the viewpoint of industrial productivity.

The Nz coefficient of the resin layer B obtained by the stretching step is preferably as high as possible, usually −0.30 or more, and preferably −0.25 or more. When the Nz coefficient of the resin layer B is set to fall within the aforementioned range, the thickness of the phase difference film can be reduced within the range that enables the phase difference film to satisfy the relationship of 0.92≦R₄₀/Re≦1.08. The upper limit value thereof is theoretically 0, but usually −0.10 or less, from the viewpoint of industrial productivity.

The Nz coefficient of the resin layer C obtained by the stretching step preferably falls within a range that is the same as the range that has been described as the range of the birefringence for the resin layer A, from a viewpoint similar to the resin layer A.

When the pre-stretch film is an isotropic raw material film, the Nz coefficient thereof is almost zero. In this case, the aforementioned Nz coefficients possessed by the resin layer A, the resin layer B, and the resin layer C obtained by the stretching step are the Nz coefficients expressed by the stretching treatment in the stretching step.

[5. Heat Treatment Step]

The method for manufacturing the phase difference film according to the present invention may include a step of performing a heat treatment on the film obtained by the stretching step at a specific temperature, after the aforementioned stretching step. The temperature of the heat treatment is preferably TgB−30° C. or higher, and more preferably TgB−20° C. or higher, and is preferably TgB or lower, and more preferably TgB−5° C. or lower. By performing such a heat treatment after the stretching step, the state of molecular chains having been oriented in the stretching step can be fixed. Accordingly, orientation relaxation of the phase difference film can be suppressed, thereby suppressing changes over time of the optical properties of the resin layers contained in the phase difference film.

The aforementioned heat treatment may also be performed after the first stretching step and before the second stretching step during the stretching step.

[6. Optional Steps]

The method for manufacturing the phase difference film according to the present invention may include optional steps in addition to the aforementioned steps.

For example, the method for manufacturing the phase difference film according to the present invention may include a step of preliminarily heating the pre-stretch film before the stretching step (preliminarily heating step). Examples of the means for heating may include an oven-type heating device, a radiation heating device, and soaking in a liquid. Among these, the oven-type heating device is preferable. The heating temperature in this step is preferably a stretching temperature −40° C. or higher, and more preferably a stretching temperature −30° C. or higher, and is preferably a stretching temperature +20° C. or lower, and more preferably a stretching temperature +15° C. or lower. Here, the stretching temperature is a temperature that is set as the temperature of the heating device.

Also, for example, the method for manufacturing the phase difference film according to the present invention may include a step of providing an optional layer on the surface of the film obtained by the stretching step. Examples of such an optional layer may include a mat layer, a hard coat layer, an antireflective layer, and an antifouling layer.

[7. Phase Difference Film]

By the aforementioned manufacturing method, there can be obtained the phase difference film as a film including the resin layer A and the resin layer B, and as necessary, the resin layer C, each having optical properties expressed in the stretching step. Since the optical properties expressed by the stretching step are maintained in the resin layers provided to the phase difference film, each of the resin layer A, the resin layer B, and the resin layer C in the phase difference film usually has the plane orientation coefficient, birefringence, and Nz coefficient having been described in the paragraph “Optical properties expressed by stretching step”. Synthesis of such optical properties of these resin layers enables the entire phase difference film including these resin layers to satisfy the relationship of 0.92≦R₄₀/Re≦1.08. Such satisfaction of the relationship of 0.92≦R₄₀/Re≦1.08 enables the phase difference film to achieve favorable viewing angle compensation properties.

Furthermore, the phase difference film obtained by the aforementioned manufacturing method can have a thin thickness. Specifically, the thickness of the phase difference film is preferably 32 μm or less, more preferably 30 μm or less, and particularly preferably 28 μm or less. The lower limit of the thickness of the phase difference film is not limited, but usually 5 μm or more. According to the aforementioned manufacturing method, such a phase difference film having a thin thickness can be easily manufactured without causing whitening by the stretching treatment.

The phase difference film preferably has a total light transmittance of 85% or more and 100% or less. The light transmittance is measured in accordance with JIS K0115 using a spectrophotometer (manufactured by Jasco Corporation, ultraviolet visible near-infrared spectrophotometer “V-570”).

The phase difference film has a haze of preferably 5% or less, more preferably 3% or less, particularly preferably 1% or less, and ideally 0%. When the value of haze is low, an image displayed on the display device provided with the phase difference film can have improved sharpness. Here, the value of haze may be an average value calculated from measurement at five locations in accordance with JIS K7361-1997 using a “turbidimeter NDH-300A” manufactured by Nippon Denshoku Industries Co., Ltd.

The phase difference film has a ΔYI of preferably 5 or less, and more preferably 3 or less. When this ΔYI falls within the aforementioned range, coloring is not caused so that favorable visibility can be obtained. The lower limit is ideally zero. The ΔYI may be measured in accordance with ASTM E313 using a “spectrophotometric colorimeter SE2000” manufactured by Nippon Denshoku Industries Co., Ltd. The same measurement is performed five times, and an arithmetic average thereof is calculated.

The phase difference film preferably has a hardness of H or higher based on JIS pencil hardness. This JIS pencil hardness may be adjusted by the type of a resin and the thickness of a resin layer. Here, JIS pencil hardness is determined by scratching the surface of a film with pencils in accordance with JIS K5600-5-4. Scratching is performed with pencils with a variety of hardness which are inclined at the angle of 45° to which 500 g force of downward load is applied. The hardness is determined as the pencil that begins to create scratches.

The phase difference film may shrink in the longitudinal direction and in the transverse direction by a heat treatment at a temperature of 60° C. and a humidity of 90% RH for 100 hours. However, the degree of shrinkage is preferably 0.5% or less, and more preferably 0.3% or less. Such a low degree of shrinkage can prevent occurrence of a phenomenon that the phase difference film is deformed and peeled off from a display device due to a shrinkage stress during use under a high-temperature and high-humidity environment. The lower limit of the degree of shrinkage is preferably 0% or more.

The size in the width direction of the phase difference film is preferably 500 mm or more, and more preferably 1000 mm or more, and is preferably 2000 mm or less.

The phase difference film may further include an optional layer in addition to the resin layer A, the resin layer B, and the resin layer C. Examples of such an optional layer may include a mat layer for providing good film sliding properties, a hard coat layer such as an impact-resistant polymethacrylate resin layer, an antireflective layer, and an antifouling layer. These optional layers may be provided by, for example, bonding after the stretching step. The optional layer may be provided by coextruding a resin for forming the optional layer, together with the resin A and the resin B as well as the resin C used as necessary, when manufacturing the pre-stretch film.

[8. Display Device]

According to the manufacturing method of the present invention, there can be achieved the phase difference film in which retardation is precisely controlled. The use of this phase difference film enables sophisticated compensation for birefringence. Therefore, the aforementioned phase difference film may be applied, alone or in combination with another member, to display devices such as a liquid crystal display device, an organic electroluminescent display device, a plasma display device, an FED (field emission display) device, and an SED (surface-conduction electron-emitter display) device.

A liquid crystal display device is usually provided with: a pair of polarizers (a light incident-side polarizer and a light emission-side polarizer) with their absorption axes orthogonal to each other; and a liquid crystal cell provided between the pair of polarizers. For example, when the phase difference film obtained by the manufacturing method according to the present invention is applied to the liquid crystal display device, the phase difference film may be provided between the pair of polarizers. At this time, the phase difference film may be provided on the light incident side with respect to the liquid crystal cell, or may be provided on the light emission side with respect to the liquid crystal cell.

The pair of polarizers, the phase difference film, and the liquid crystal cell are usually combined to form a liquid crystal panel as a single member. The liquid crystal display device has a structure in which light is emitted from a light source to this liquid crystal panel in order to display an image on a display surface present on the light emission side of the liquid crystal panel. At this time, the phase difference film exerts an excellent polarizing plate compensation function based on precisely controlled retardation, thereby enabling reduction of light leakage when the display surface of the liquid crystal display device is viewed from an inclined direction. Furthermore, the phase difference film usually has an excellent optical function other than the polarizing plate compensation function, thereby enabling further improvement of visibility of the liquid crystal display device.

Examples of the drive mode of the liquid crystal cell may include an in-plane switching (IPS) mode, a vertical alignment (VA) mode, a multi-domain vertical alignment (MVA) mode, a continuous pinwheel alignment (CPA) mode, a hybrid alignment nematic (HAN) mode, a twisted nematic (TN) mode, a super-twisted nematic (STN) mode, and an optical compensated bend (OCB) mode. Among these, the in-plane switching mode and the vertical alignment mode are preferable, and the in-plane switching mode is particularly preferable. Although the liquid crystal cell having the in-plane switching mode generally has a wide viewing angle, application of the aforementioned phase difference film can further widen the viewing angle.

The phase difference film may be bonded to a liquid crystal cell or a polarizer. For example, the phase difference film may be bonded to both surfaces of a polarizer, or may be bonded only to one surface thereof. Known adhesive agents may be used for bonding.

As the phase difference film, one film may be used alone, or two or more phase difference films may be used in combination.

In addition, when the phase difference film is provided to a display device, another phase difference film may be further used in combination. For example, when the phase difference film obtained by the manufacturing method of the present invention is provided to a liquid crystal display device including a liquid crystal cell having the vertical alignment mode, another phase difference film for improving viewing angle characteristics may be provided between the pair of polarizers in addition to the phase difference film obtained by the manufacturing method of the present invention.

### EXAMPLES

Hereinafter, the present invention will be specifically described by illustrating Examples. However, the present invention is not limited to the following Examples, which may be optionally modified within the scope not departing from the claims of the present invention and their equivalents.

In the following description “%” and “parts” both indicating quantity are based on weight, unless otherwise stated. Also, the below-described operation was performed under the conditions of normal temperature and normal pressure, unless otherwise stated.

[Evaluation Methods]

(1. Method for Measuring Glass Transition Temperature)

The glass transition temperature was measured by increasing a temperature at 20° C./min by differential scanning calorimetry (DSC) in accordance with JIS K7121.

(2. Method for Measuring Film Thickness)

The film thickness was measured by observing the cross-sectional surface of a film through an optical microscope. For a film including a plurality of layers, the thickness of each layer was measured.

(3. Method for Measuring Three-Dimensional Refractive Index nx, ny and nz; Birefringence Δno; Plane Orientation Coefficient Δnt; and Nz Coefficient)

Using a prism coupler (manufactured by Metricon Corporation, Model 2010), the three-dimensional refractive index of each of the resin layer A/the resin layer B/the resin layer C of a three-layer film was measured. Here, the three-dimensional refractive index is a refractive index nx in the width direction of a film, a refractive index ny in the lengthwise direction, and a refractive index nz in the thickness direction. At this time, the three-dimensional refractive index of the resin layer A was measured by measuring the front surface of the film. The three-dimensional refractive index of the resin layer C was measured by measuring the back surface of the film. Furthermore, the three-dimensional refractive index of the resin layer B was measured by removing the polycarbonate layer on the film surface by etching with a dry etching apparatus (“RIE-10NE” manufactured by Samco, Inc.) and thereafter measuring the exposed surface of the resin layer B. The measurement wavelength was 532 nm.

On the basis of the obtained three-dimensional refractive index, the birefringence Δno, plane orientation coefficient Δnt, and Nz coefficient were calculated according to the following formulas:

Birefringence Δno=nx−ny,

Plane orientation coefficient Δnt=(nx+ny)/2−nz,

and

Nz coefficient=(nx−nz)/(nx−ny).

(4. Method for Measuring Contrast)

A polarizing plate and a phase difference film were removed from an LCD panel of a tablet device (trade name: “iPad”, the second generation, manufactured by Apple Inc.), and the polarizing plate multilayer body to be evaluated was attached instead. The attachment was performed by bonding the polarizing plate composite to the LCD panel via an optical transparent adhesive sheet (“LUCIACS CS9621T” manufactured by Nitto Denko Corporation).

Measurement was performed by starting up the tablet device and scanning the brightness of its bright display and dark display in increments of 5° within the range of an azimuth angle of 0° to 360° and a polar angle of 0° to 80°.

With respect to the measured values at each viewing angle, the brightness of bright display was divided by the brightness of dark display. The calculated value was defined as the contrast at the viewing angle. Of the contrasts at the respective viewing angles obtained as described above, the lowest value within the viewing angle scanning range was determined as an index value of contrast.

(5. Method for Measuring Ratio R₄₀/Re Between Retardation Re at Incident Angle of 0° and Retardation R₄₀ at Incident Angle of 40°)

Retardation Re at an incident angle of 0° and retardation R₄₀ at an incident angle of 40° were measured with AxoScan (a high-speed polarization and phase difference measuring system, manufactured by Axometrics Inc.). From the measured Re and R₄₀, R₄₀/Re was calculated. At this time, the measurement wavelength was 532 nm.

(6. Method for Evaluating Whitening of Film)

Whitening of the film was evaluated by visually observing the film.

### Example 1

### 1-1. Manufacture of Pre-Stretch Film

A film molding apparatus for three-type three-layer coextrusion molding (a resin layer (a)/a resin layer (b)/a resin layer (c)) was prepared. This film molding apparatus includes a uniaxial extruder for each of the resin layer (a), the resin layer (b), and the resin layer (c). Each uniaxial extruder includes a double flight-type screw.

Into the uniaxial extruder for the resin layer (b) of the film molding apparatus, pellets of a styrene-maleic anhydride copolymer resin (“Dylark D332” manufactured by Nova Chemicals Inc., glass transition temperature: 128° C.) were charged, and melted at 250° C.

Furthermore, into the uniaxial extruder for the resin layer (a) and the resin layer (c) of the film molding apparatus, pellets of a polycarbonate resin (“Iupilon E2000” manufactured by Mitsubishi Engineering-Plastics Corporation, glass transition temperature: 151° C.) were charged, and melted at 270° C.

The melted styrene-maleic anhydride copolymer resin at 250° C. was supplied into a manifold for the resin layer (b) of a multi-manifold die (arithmetic average roughness of die slip Ra: 0.1 μm), through a leaf disc-shaped polymer filter having an opening of 3 μm.

Furthermore, the melted polycarbonate resin at 270° C. was supplied into a manifold for the resin layer (a) and the resin layer (c), through a leaf disc-shaped polymer filter having an opening of 3 μm.

The styrene-maleic anhydride copolymer resin and the polycarbonate resin were simultaneously extruded from the multi-manifold die at 260° C. and molded into a film shape. The molded film-like melted resin was cast on a cooling roll adjusted at a surface temperature of 110° C., and subsequently passed through a gap of two cooling rolls adjusted at a surface temperature of 50° C. for curing. Accordingly, there was obtained a pre-stretch film PF(I) with a thickness of 100.4 μm including a resin layer (a) made of the polycarbonate resin (thickness: 13 μm), a resin layer (b) (thickness: 86 μm) made of the styrene-maleic anhydride copolymer resin, and a resin layer (c) (thickness: 1.4 μm) made of the polycarbonate resin in this order. It was confirmed that this pre-stretch film PF(I) satisfies the aforementioned requirement P when the stretching temperatures in the width direction and the lengthwise direction as described later were employed as the temperatures T1 and T2.

### 1-2. Manufacture of Stretched Film

The obtained pre-stretch film PF(I) was stretched by a step of performing uniaxial stretching in the width direction at 155° C. using a tenter transverse stretching machine by a factor of 3.2 and a step of thereafter performing uniaxial stretching in the lengthwise direction at 126° C. using a longitudinal stretching machine by a factor of 1.3. Then, a step of performing a heat treatment at 120° C. was further performed. Thus, a stretched film F(I) was obtained. The film width during the heat treatment was set to be 0.998 times the width of the film immediately after the stretching by the longitudinal stretching machine. This stretched film F(I) is a multilayer film including a resin layer A obtained by stretching the resin layer (a), a resin layer B obtained by stretching the resin layer (b), and a resin layer C obtained by stretching the resin layer (c), in this order. The total thickness thereof was 28 μm.

A part of the obtained stretched film F(I) was cut out to prepare a sample. Then, the birefringence Δno and plane orientation coefficient Δnt of each layer of the sample were measured. The measurement result for the resin layer A was Δno=0.00816 and Δnt=0.02642. The measurement result for the resin layer B was Δno=0.00501 and Δnt=−0.00358. The measurement result for the resin layer C was Δno=0.00820 and Δnt=0.02649. Furthermore, the Nz coefficient of each layer was measured.

Further, the retardation Re at an incident angle of 0° and retardation R₄₀ at an incident angle of 40° of the obtained stretched film F(I) were measured to calculate R₄₀/Re.

### 1-3. Manufacture of Polarizing Plate Multilayer Body

The surface on the resin layer C side of the film F(I) was bonded to a polarizing plate (“LLC2-5618” manufactured by Sanritz Corporation) to obtain a polarizing plate multilayer body. This bonding was performed via an optical transparent adhesive sheet (“LUCIACS CS9621T” manufactured by Nitto Denko Corporation) such that the slow axis of the stretched film F(I) is orthogonal to the absorption axis of the polarizing plate.

The measured contrast of the obtained polarizing plate multilayer body was 348.

### Example 2

The layer thickness of the pre-stretch film PF(I) was changed as indicated in Table 1 shown below by adjusting the size of the resin discharge port of the multi-manifold die.

The stretched film F(I) was manufactured and evaluated in the same manner as that in Example 1 except for the aforementioned matters.

### Example 3

The type of the polycarbonate resin used in the resin layer A and the resin layer C was changed to “Iupilon S3000” manufactured by Mitsubishi Engineering-Plastics Corporation (glass transition temperature: 149° C.)

Furthermore, the layer thickness of the pre-stretch film PF(I) was changed as indicated in Table 1 shown below by adjusting the size of the resin discharge port of the multi-manifold die.

In addition, the stretching conditions of the pre-stretch film PF(I) were changed as indicated in Table 1 shown below.

The stretched film F(I) was manufactured and evaluated in the same manner as that in Example 1 except for the aforementioned matters.

### Comparative Example 1

The type of the polycarbonate resin used in the resin layer A and the resin layer C was changed to “Wonderlite PC115” manufactured by Asahi Kasei Chemicals Corporation (glass transition temperature: 144° C.)

Furthermore, the layer thickness of the pre-stretch film PF(I) was changed as indicated in Table 1 shown below by adjusting the size of the resin discharge port of the multi-manifold die.

In addition, the stretching conditions of the pre-stretch film PF(I) were changed as indicated in Table 1 shown below.

The stretched film F(I) was manufactured and evaluated in the same manner as that in Example 1 except for the aforementioned matters.

### Comparative Example 2

The layer thickness of the pre-stretch film PF(I) was changed as indicated in Table 1 shown below by adjusting the size of the resin discharge port of the multi-manifold die.

Furthermore, the stretching conditions of the pre-stretch film PF(I) were changed as indicated in Table 1 shown below.

The stretched film F(I) was manufactured and evaluated in the same manner as that in Example 1 except for the aforementioned matters.

[Results]

The results of Examples and Comparative Examples are shown in Table 1 below. In this Table 1, meanings of the abbreviations are as follows.

Layer A: Resin layer A

Layer B: Resin layer B

Layer C: Resin layer C

Tg: Glass transition temperature

St amount: Weight ratio of structural unit formed by polymerizing styrene

PC: Polycarbonate

Pst: Polystyrene

Δno: Birefringence

Δne: Plane orientation coefficient

Nz: Nz coefficient

TABLE 1
[Constituents and results of Examples and Comparative Examples]

| | | | | | Comparative | Comparative |
|---|---|---|---|---|---|---|
| | | Example 1 | Example 2 | Example 3 | Example 1 | Example 2 |
| Layers A | Type | E2000 | E2000 | S3000 | PC115 | E2000 |
| and C | Tg | 151° C. | 151° C. | 149° C. | 144° C. | 151° C. |
| Layer B | Type | D332 | D332 | D332 | D332 | D332 |
| | St amount | 82% | 82% | 82% | 82% | 82% |
| | Tg | 128° C. | 128° C. | 128° C. | 128° C. | 128° C. |
| Thickness of | Layer A (PC) | 13.0 | 13.0 | 14.0 | 16.0 | 14.0 |
| pre-stretch | Layer B (Pst) | 86.0 | 88.0 | 85.0 | 85.0 | 112.0 |
| film (μm) | Layer C (PC) | 1.4 | 2.3 | 1.3 | 1.7 | 1.9 |
| | Total | 100.4 | 103.3 | 100.3 | 102.7 | 127.9 |
| First stretch | Temperature (° C.) | 155 | 155 | 153 | 148 | 155 |
| (transverse | Factor (X) | 3.2 | 3.2 | 3.2 | 3.2 | 3.2 |
| stretch) | | | | | | |
| Second stretch | Temperature (° C.) | 126 | 126 | 126 | 126 | 128 |
| (longitudinal | Factor (X) | 1.3 | 1.3 | 1.3 | 1.3 | 1.3 |
| stretch) | | | | | | |
| Heat | Temperature (° C.) | 120 | 120 | 120 | 120 | 120 |
| treatment | Factor (X) | 0.998 | 0.998 | 0.998 | 0.998 | 0.998 |
| Stretched | | | | | | |
| film | | | | | | |
| Total | (μm) | 27.5 | 28.4 | 27.5 | 28.1 | 35.1 |
| thickness | | | | | | |
| Layer A | Δno | 0.00816 | 0.00818 | 0.00818 | 0.00816 | 0.00814 |
| (PC) | Δnt | 0.02642 | 0.02645 | 0.02644 | 0.02641 | 0.02643 |
| | Nz | 3.74 | 3.73 | 3.73 | 3.73 | 3.75 |
| Layer B | Δno | 0.00501 | 0.00503 | 0.00480 | 0.00407 | 0.00364 |
| (Pst) | Δnt | −0.00358 | −0.00355 | −0.00381 | −0.00462 | −0.00305 |
| | Nz | −0.21 | −0.21 | −0.29 | −0.64 | −0.34 |
| Layer C | Δno | 0.00820 | 0.00818 | 0.00816 | 0.00815 | 0.00815 |
| (PC) | Δnt | 0.02649 | 0.02645 | 0.02643 | 0.02641 | 0.02650 |
| | Nz | 3.73 | 3.73 | 3.74 | 3.74 | 3.75 |
| R₄₀/Re | | 1.03 | 1.03 | 1.04 | 1.04 | 1.02 |
| Contrast | | 348 | 351 | 340 | 301 | 332 |
| Whitening | | No | No | No | No | No |

### DISCUSSION

In Examples, there were obtained the phase difference films that satisfy the relationship of 0.92≦R₄₀/Re≦1.08 and have a thin thickness. Furthermore, it was observed that use of these phase difference films achieved high contrast. Thus, it was confirmed that, according to this phase difference film, light leakage of a liquid crystal panel can be prevented.

In contrast, although the phase difference film manufactured in Comparative Example 1 has a thin thickness, the film had poor light leakage prevention ability, failing to obtain high contrast. Although the contrast of Comparative Example 2 was higher than that of Comparative Example 1, it was lower than those of the Examples. Furthermore, the film failed to be thinned.

Comparison between Examples and Comparative Example 1 demonstrates that the glass transition temperatures of the resin A and the resin B satisfying specific conditions is effective for thinning the phase difference film having desired R₄₀/Re. In Comparative Example 1, the glass transition temperature of the resin A is low, and a difference in glass transition temperature between the resin A and the resin B is small. It is inferred that this inhibited generation of large orientation degree by stretching, thereby suppressing expression of desired optical properties.

Furthermore, comparison between Examples and Comparative Example 2 demonstrates that a phase difference film having desired R₄₀/Re with a thin thickness can be realized when the optical properties that each resin layer expresses during the stretching step are set in appropriate ranges. In Comparative Example 2, the birefringence and Nz coefficient of the resin layer B are not appropriate. Therefore, each resin layer is required to be thicker for achieving the phase difference film having desired R₄₀/Re. It is inferred that this caused the phase difference film to become thick.

1. A method for manufacturing a phase difference film from a pre-stretch film, the pre-stretch film including a resin layer (a) made of a resin A containing polycarbonate, and a resin layer (b) provided on one surface of the resin layer (a) and made of a resin B having a negative intrinsic birefringence, the phase difference film including a resin layer A made of the resin A, and a resin layer B provided to one surface of the resin layer A and made of the resin B, wherein
retardation Re at an incident angle of 0° and retardation R₄₀ at an incident angle of 40° of the phase difference film satisfy a relationship of 0.92≦R₄₀/Re≦1.08,
the pre-stretch film is a film wherein, a phase of a linearly polarized light perpendicularly entering the film plane and having a vibration plane of an electric vector on an XZ plane relative to a linearly polarized light perpendicularly entering the film plane and having a vibration plane of an electric vector on a YZ plane delays when uniaxial stretching in an X-axis direction is performed at a temperature T1, and advances when uniaxial stretching in the X-axis direction is performed at a temperature T2 that is different from the temperature T1, provided that, in the pre-stretch film, the X-axis is the uniaxial stretching direction, the Y-axis is a direction orthogonal to the uniaxial stretching direction in a film plane, and the Z-axis is a film thickness direction,
the manufacturing method comprises a stretching step including a first stretching step of performing a uniaxial stretching treatment on the pre-stretch film in one direction at one of the temperatures T1 and T2, and a second stretching step of performing a uniaxial stretching treatment on the film in a direction orthogonal to the one direction of the uniaxial stretching treatment performed in the first stretching step at the other of the temperatures T1 and T2,
by the stretching step, the resin layer A having a plane orientation coefficient of more than 0.025 is obtained as a result of the stretching of the resin layer (a), and the resin layer B having a birefringence of 0.004 or more and an Nz coefficient of −0.30 or more is obtained as a result of the stretching of the resin layer (b),
the resin A has a glass transition temperature TgA of 147° C. or higher, and
the resin B has a glass transition temperature TgB that satisfies a relationship of TgA−TgB>20° C.

2. The method for manufacturing a phase difference film according to claim 1, wherein the resin B contains a styrene-maleic anhydride copolymer.

3. The method for manufacturing a phase difference film according to claim 1, comprising a step of performing a heat treatment at a temperature of TgB−30° C. or higher and TgB or lower, after the stretching step.

4. The method for manufacturing a phase difference film according to claim 1, wherein
the pre-stretch film further includes a resin layer (c) made of a resin C containing polycarbonate and provided on a surface opposite to the resin layer (a) of the resin layer (b),
the phase difference film further includes a resin layer C made of the resin C and provided on a surface opposite to the resin layer A of the resin layer B, and
by the stretching step, the resin layer C having a plane orientation coefficient of more than 0.025 is obtained as a result of the stretching of the resin layer (c).

5. A phase difference film comprising: a resin layer A made of a resin A containing polycarbonate; and a resin layer B provided on one surface of the resin layer A and made of a resin B having a negative intrinsic birefringence, wherein
retardation Re at an incident angle of 0° and retardation R₄₀ at an incident angle of 40° satisfy a relationship of 0.92≦R₄₀/Re≦1.08,
the resin layer A has a plane orientation coefficient of more than 0.025,
the resin layer B has a birefringence of 0.004 or more and an Nz coefficient of −0.30 or more,
the resin A has a glass transition temperature TgA of 147° C. or higher, and
the resin B has a glass transition temperature TgB that satisfies a relationship of TgA−TgB>20° C.

6. The phase difference film according to claim 5, wherein the resin B contains a styrene-maleic anhydride copolymer.

7. The phase difference film according to claim 5, further comprising a resin layer C made of a resin C containing polycarbonate and provided on a surface opposite to the resin layer A of the resin layer B,
wherein the resin layer C has a plane orientation coefficient of more than 0.025.
